(19) United States
(12) Patent Application Publication
(10) Pub. No.: US 2026/0279183 A1
(43) Pub. Date: Sep. 17, 2026

(54) METHOD FOR DETECTING FLOOD AND APPARATUS AND SYSTEM FOR THE SAME

(71) Applicant: Electronics and Telecommunications Research Institute, Daejeon (KR)

(72) Inventor: Sang Won GHYME, Daejeon (KR)

(21) Appl. No.: 19/530,255

(22) Filed: Feb. 4, 2026

(30) Foreign Application Priority Data
Mar. 14, 2025 (KR) 10-2025-0033057

(51) Int. Cl. G08B 21/10; G06V 10/141; G06V 10/82; G06V 20/52

(52) U.S. Cl. CPC G08B 21/10; G06V 10/141; G06V 10/82; G06V 20/52

(57) ABSTRACT

The present disclosure relates to a method for detecting a flood and an apparatus and a system for the same. A system for detecting a flood according to an embodiment of the present disclosure may include a camera array including N (N is an integer greater than or equal to 1) cameras; and a flood detection processing apparatus that generates flood information by applying a neural network model in a video classification method based on N sample video data acquired from the camera array.

### CROSS-REFERENCE TO RELATED APPLICATION

This application claims priority under 35 U.S.C § 119 to Korean Patent Application No. 10-2025-0033057 filed in the Korean Intellectual Property Office on Mar. 14, 2025, the entire contents of which are hereby incorporated by reference.

### TECHNICAL FIELD

The present disclosure relates to a method for detecting a flood and an apparatus and a system for the same.

### BACKGROUND ART

The technology is needed that may effectively monitor, early detect and immediately notify a flood which occurs within a building or outdoors due to a sudden heavy rain.

Previously, a direct monitoring method by humans or methods using a sensor (e.g., a flood system) have been used to detect a flood. A direct monitoring method is a method in which a small number of persons in charge directly monitor multi-channel CCTV images to check flood conditions when there is a risk of flood due to a heavy rain, a typhoon, etc. This method has a physical limitation for a person in charge to directly monitor numerous channels, and has a problem in reduced accuracy and efficiency because it is known to overlook more than 95% of a field situation during monitoring for a long time (e.g., 22 minutes or more). Meanwhile, a method for using a flood system is the most traditional method for installing a flood system in a sensor type, which is mainly intended to check a flood depth (m) after a flood. Since electricity and communication facilities are needed for real-time monitoring using a sensor and there are problems regarding securing a communication network, communication costs and sensor maintenance costs when operating a multi-channel, it is hardly utilized domestically, and even in foreign countries, a low-cost flood system is used that a person in charge performs checking directly, not in real time.

Accordingly, to solve the problems of the existing flood detection method, a method for using the computer vision technology or using the artificial intelligence technology is being discussed. For example, methods for reducing false detection by inferring whether a flood occurs in the unit of an actually captured image through the machine learning of flood images and improving the accuracy of flood detection have been recently explored. However, the image-based flood detection technology has a problem in overcoming false detection due to the noise or optical features of a captured image, so a new method for solving this is required.

### DISCLOSURE

### Technical Problem

The present disclosure is to provide a method and an apparatus for detecting a flood based on a video.

The present disclosure is to provide a flood detection method and apparatus that may always operate under all weather conditions and time zones.

The present disclosure is to provide a flood detection method and apparatus without privacy invasion.

The technical objects to be achieved by the present disclosure are not limited to the above-described technical objects, and other technical objects which are not described herein will be clearly understood by those skilled in the pertinent art from the following description.

### Technical Solution

A system for detecting a flood according to an embodiment of the present disclosure may include a camera array including N (N is an integer greater than or equal to 1) cameras; and a flood detection processing apparatus that generates flood information by applying a neural network model in a video classification method based on N sample video data acquired from the camera array.

A flood detection processing apparatus according to an additional embodiment of the present disclosure may include at least one transceiver; at least one memory; and at least one processor. At least one processor may be configured to acquire N sample video data respectively corresponding to N (N is an integer greater than or equal to 1) cameras through the at least one transceiver and store the same in the memory; calculate a sample unit flood degree based on the N sample video data and K (K is the integer greater than or equal to 1) neural network models in a video classification method; and output flood information based on the sample unit flood degree through the at least one transceiver.

A flood detection processing method according to an additional embodiment of the present disclosure may include acquiring N sample video data respectively corresponding to N (N is an integer greater than or equal to 1) cameras; calculating a sample unit flood degree based on the N sample video data and K (K is the integer greater than or equal to 1) neural network models in a video classification method; and outputting flood information based on the sample unit flood degree.

In at least one non-transitory computer-readable medium for storing at least one instruction according to an additional embodiment of the present disclosure, the at least one instruction may be executed by at least one processor to control an apparatus to perform an operation for acquiring N sample video data respectively corresponding to N (N is an integer greater than or equal to 1) cameras; an operation for calculating a sample unit flood degree based on the N sample video data and K (K is the integer greater than or equal to 1) neural network models in a video classification method; and an operation for outputting flood information based on the sample unit flood degree.

In some embodiments of the present disclosure, the N sample video data may correspond to video data in a predetermined time period of N video data capturing the same direction through the N cameras.

In some embodiments of the present disclosure, N*M sample videos in which M (M is an integer greater than or equal to 1) different noise features are given to each of the N sample video data may be generated.

In some embodiments of the present disclosure, each of the N*M sample video data may be partitioned into P (P is an integer greater than or equal to 2) patch unit videos.

In some embodiments of the present disclosure, a part or all of the P patch unit videos may include an overlapping region.

In some embodiments of the present disclosure, N*M*K inference values may be acquired for each patch unit video by applying K (K is an integer greater than or equal to 1) neural network models in a video classification method to each of the P patch unit videos.

In some embodiments of the present disclosure, for each patch unit video, an analysis value based on the N*M*K inference values may be acquired.

In some embodiments of the present disclosure, a sample unit flood degree may be calculated based on P analysis values for the P patch unit videos.

In some embodiments of the present disclosure, the sample unit flood degree may be calculated based on P_v analysis values corresponding to a valid region among the P analysis values.

In some embodiments of the present disclosure, when an analysis value greater than or equal to a predetermined number of thresholds has a value corresponding to a flood among the P_v analysis values, detection information representing that a flood is detected in the sample unit may be generated.

In some embodiments of the present disclosure, when an analysis value less than a predetermined number of thresholds has a value corresponding to a flood among the P_v analysis values, detection information representing that a flood is not detected in the sample unit may be generated.

In some embodiments of the present disclosure, a flood detection processing apparatus may perform at least one of outputting flood information based on the sample unit flood degree or outputting a flood warning corresponding to the flood information.

In some embodiments of the present disclosure, an illuminator that illuminates a direction captured by the N cameras may be further included.

In some embodiments of the present disclosure, flood-related feature information may be added to N video data captured through the N cameras by patterned light irradiated from the illuminator.

In some embodiments of the present disclosure, a neural network model learned about a video to which the flood-related feature is added may be applied to the flood detection processing apparatus.

In some embodiments of the present disclosure, the illuminator may operate according to a predetermined schedule.

In some embodiments of the present disclosure, whether the illuminator operates may be adjusted according to a control signal by the flood detection processing apparatus.

The features briefly summarized above with respect to the present disclosure are just an exemplary aspect of a detailed description of the present disclosure described below, and do not limit a scope of the present disclosure.

### Technical Effect

According to the present disclosure, a method and an apparatus for detecting a flood based on a video may be provided.

According to the present disclosure, a flood detection method and apparatus that may always operate under all weather conditions and time zones may be provided.

According to the present disclosure, a flood detection method and apparatus without privacy invasion may be provided.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 represents an example of a block diagram for describing the structure of a flood detection system according to the present disclosure.

FIG. 2 represents an example of a block diagram for describing the detailed structure of a flood detection processing apparatus according to the present disclosure.

FIG. 3 represents an example of a block diagram for describing the detailed structure of a flood detection unit according to the present disclosure.

FIG. 4 is a diagram for describing an example of a patch unit video according to the present disclosure.

FIG. 5 is a diagram for describing an example of a flood detection method according to the present disclosure.

FIG. 6 represents an example of a block diagram for a flood detection apparatus according to the present disclosure.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of “and/or” includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

The present disclosure describes various examples of a video-based flood detection methods and apparatus.

The existing methods for detecting a flood accident are divided into methods using a sensor such as a flood system and methods using an image captured by a camera. For a method using a sensor, many sensors must be installed closely, so it has problems that a lot of expenses are required and many sensors must be maintained. A monitoring method through camera images may monitor a wide space with one camera, but since a person directly performs monitoring, it has problems that it is difficult to monitor for 24 hours and monitor intensively for a long time. Recently, methods for advancing performance by improving the existing technologies based on AI or for performing monitoring for 24 hours by a machine instead of a person are being discussed.

The computer vision technology or the AI technology was used as a method for detecting a flood. The recent AI technology is a method for inferring whether a flood occurs for images from a CCTV by learning flood images, and methods for improving accuracy and reducing false detection are being explored.

The examples of the present disclosure provide flood monitoring by utilizing a video (e.g., a video captured through a CCTV), and describe a flood monitoring method and system that enables automated monitoring by a computer, has no privacy invasion problems, enables real-time monitoring for 24 hours and enables monitoring regardless of weather changes and day and night changes.

In particular, the present disclosure may improve the quality of an image to effectively detect whether a flood occurs based on a video, and use a spatiotemporal image analysis method to monitor a flood quickly and accurately.

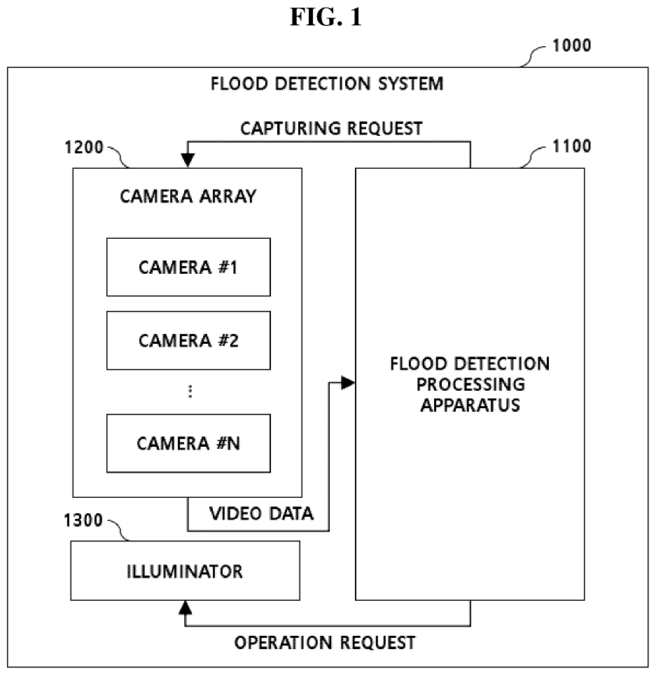

FIG. 1 represents an example of a block diagram for describing the structure of a flood detection system according to the present disclosure.

The flood detection system 1000 may include the flood detection processing apparatus 1100, the camera array 1200 and the illuminator 1300. For example, the flood detection system 1000 may be implemented by being added or substituted with the existing CCTV apparatus.

The flood detection processing apparatus 1100 may transmit a control signal to the camera array 1200 and/or the illuminator 1300 and acquire video data from the camera array 1200. A control signal may include a capturing request or an indication signal for the camera array 1200 and/or an operation request or indication for the illuminator 1300.

A general CCTV apparatus may include one camera apparatus for capturing a video and a communication apparatus for transmitting an image captured by a camera to the outside or receiving a request from the outside. The camera array 1200 of the flood detection system 1000 of the present disclosure may include N (e.g., N is an integer greater than or equal to 1) cameras that capture the same direction. In addition, the flood detection system 1000 of the present disclosure may include the illuminator 1300 that illuminates a direction with which a camera array is facing. In addition, the flood detection system 1000 of the present disclosure may include the flood detection processing apparatus 1100 that may independently process whether a flood is detected based on video data captured and provided by the camera array 1200 and includes a function for transmitting and receiving related data.

In the flood detection system 1000 of the present disclosure, the camera array 1200 may include one camera or a plurality of cameras. In the flood detection system 1000 of the present disclosure, the illuminator 1300 may be omitted.

When the flood detection system 1000 has a plurality of cameras capturing the same direction, each camera may acquire different video data.

Each camera (e.g., camera #1, camera #2, . . . , camera #N) apparatus within the camera array 1300 may have an internal difference due to image compression or mechanical noise, and may have an external difference in the environment such as illumination, etc. When only one camera is used, false detection for whether a flood occurs may occur due to internal and/or external noise as described above. By using video data captured by multiple cameras, the impact of noise may be minimized.

Whether a flood occurs may be detected even in a video captured without using the illuminator 1300, but flood detection performance may deteriorate according to a change in the external environment such as weather conditions or a time zone (e.g., a dark night time zone without sunlight or in case of rain even in a day time zone, etc.). This performance deterioration may occur because the features of a flood may not be extracted properly from a video. To supplement this problem, the illuminator 1300 may be physically turned on to add flood-related features (e.g., light reflection) to video data captured by the camera array 1200. To enhance flood detection performance when using the illuminator 1300, a neural network model that additionally learns videos to which lighting effects or flood-related features are added may be applied to a flood detection processing apparatus.

A method for adjusting whether the illuminator 1300 operates according to a predetermined schedule (or periodically) may be applied basically to ensure that it automatically operates in a dark time zone and automatically turns off in a bright time zone. In addition or separately, whether the illuminator 1300 operates may be adjusted by an operation request. For example, a method may be applied that the flood detection processing apparatus 1100 requests the illuminator 1300 to operate when it is determined through video analysis that lighting is needed and requests the illuminator 1300 to stop operating when lighting is not needed.

Furthermore, the illuminator 1300 may be configured to always operate in a specific time zone. In addition, the illuminator 1300 may operate periodically in a predetermined time unit (e.g., every second) to add various lighting features to a video. For example, the illuminator 1300 may irradiate patterned light to include various features in a video. For example, lighting features on which a corresponding lighting pattern is reflected may be included in a video captured by the camera array 1200 at a location where the illuminator 1300 provides lighting while blinking in a predetermined pattern.

The flood detection processing apparatus 1100 may independently generate a detection result and transmit a detection result to the outside by using a separate processor for image processing and AI inference within the flood detection system 1000.

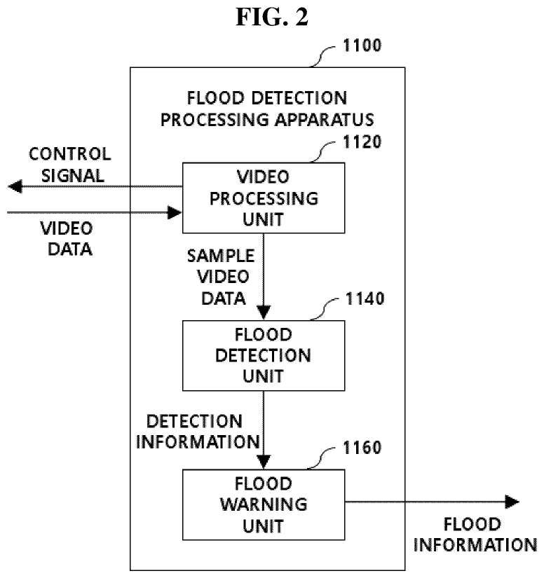

FIG. 2 represents an example of a block diagram for describing the detailed structure of a flood detection processing apparatus according to the present disclosure.

The flood detection processing apparatus 1100 may include the video processing unit 1120 that processes and analyzes an image captured by using a camera, the flood detection unit 1140 that inputs sample video data into a neural network model for flood detection to generate and analyze an inference result and the flood warning unit 1160 that transmits a detection result to the outside.

The video processing unit 1120 may transmit a control signal (e.g., a capturing request) requesting the camera array 1200 to capture a video and accumulate image frames captured and transmitted by the camera array 1200 to acquire sample video data in a predetermined identical time period (e.g., several seconds). Accordingly, N sample video data respectively corresponding to the number of cameras (e.g., N) included in the camera array 1200 may be acquired. For example, the first sample video data corresponding to the first camera may be acquired, the second sample video data corresponding to the second camera may be acquired, . . . , the Nth sample video data corresponding to the Nth camera may be acquired.

The video processing unit 1120 may perform a variety of processing such as image compression, reconstruction, etc. for a sample video to generate sample videos to which different noise features are given. For example, even for a video captured by one camera, M sample videos to which M (e.g., M is an integer greater than or equal to 1) distinct noise features are given may be generated. For example, the first sample video to which the first noise feature is given may be generated, the second sample video to which the second noise feature is given may be generated, . . . , the Mth sample video to which the Mth noise feature is given may be generated.

Furthermore, since M sample videos may also be generated for a video captured by each of the N cameras, N*M sample videos may be generated or prepared. For example, the first M sample videos corresponding to M noise features may be generated for a sample video corresponding to the first camera, the second M sample videos corresponding to M noise features may be generated for a sample video corresponding to the second camera, . . . , the Nth M sample videos corresponding to M noise features may be generated for a sample video corresponding to the Nth camera.

The video processing unit 1120 may trace a change in illumination through image analysis. When illumination is lower than a predetermined threshold, the video processing unit 1120 may transmit a control signal (e.g., an operation request) to the illuminator 1300. In addition, when a control signal that causes the illuminator 1300 to irradiate patterned light is transmitted as described above, a predetermined lighting feature may be added to video data captured by the camera array 1200.

In this way, the video processing unit 1120 may prepare a variety of sample video data to minimize the effects of noise included in an image.

The flood detection unit 1140 may use sample video data generated by the video processing unit 1120 as input data, apply it to a flood detection neural network model to calculate an inference value for whether a flood occurs and combine inference values to generate flood detection information.

The flood warning unit 1160 may combine and trace detection information to generate flood information. Flood information may include various information such as whether a flood occurs, whether a flood warning is issued, a current flood depth, a predicted flood depth, a predicted flood occurrence time, a predicted flood release time, etc. Accordingly, the flood warning unit 1160 may transmit flood information to a control center to issue a flood warning or prepare for a flood and/or may independently output a flood warning in response to flood information.

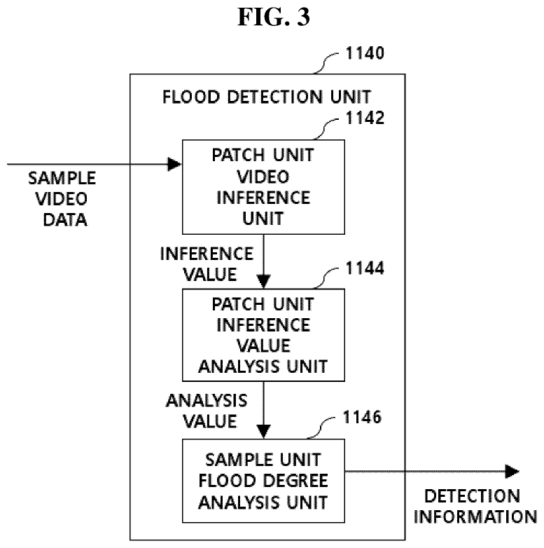

FIG. 3 represents an example of a block diagram for describing the detailed structure of a flood detection unit according to the present disclosure.

The flood detection unit 1140 may include the patch unit video inference unit 1142, the patch unit inference value analysis unit 1144 and the sample unit flood degree analysis unit 1146.

The patch unit video inference unit 1142 may generate patch unit video data by partitioning sample video data input from the video processing unit 1120 in a grid form. In other words, each patch region may correspond to a part of a video screen.

In addition, each patch unit video may include a region that partially overlaps with the immediately neighboring patch unit video or may not overlap.

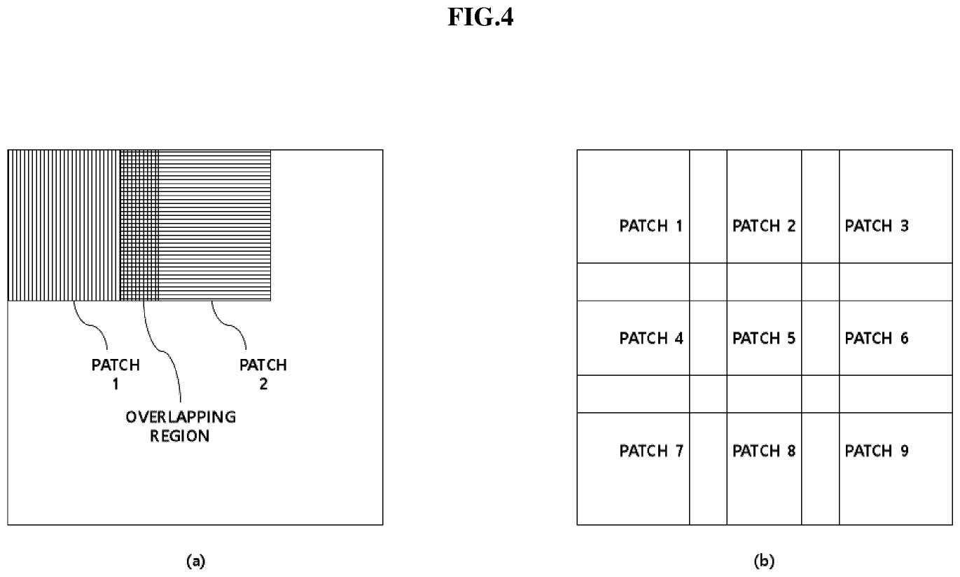

FIG. 4 is a diagram for describing an example of a patch unit video according to the present disclosure.

Referring to FIG. 4(a), in an image corresponding to one frame of a sample video, a top-left region may be defined as Patch 1 and a top-middle region may be defined as Patch 2. Patch 1 and Patch 2 may be defined to overlap partially. The consecutive images corresponding to the same one patch region across multiple frames may configure one patch unit video data.

Referring to FIG. 4(b), it may be assumed that the sizes of patches are the same on one screen. Accordingly, similar to Patch 1 and Patch 2 partially overlapping, Patch 2 and Patch 3 may also overlap partially. Furthermore, Patch 1 may overlap partially with Patch 4 and may also overlap partially with Patch 5. In this way, each patch may be defined to overlap partially with a neighboring patch.

In the example of FIG. 4, the number, size and location of patches are just exemplary, and patches of various numbers, sizes and locations may also be defined. In addition, patches do not necessarily need to have the same shape. In addition, some patches may overlap with other patches, but some patches may not overlap with other patches.

The patch unit video inference unit 1142 may calculate an inference value for each patch unit video by using a neural network model in a video classification method.

The consecutive images may also include different noise characteristics for each image. Accordingly, when a neural network model in an image classification method is used, an inference result continues to fluctuate for each image, so it may be difficult to obtain a stable result. Accordingly, an inference value in a patch unit video unit may be acquired by using a neural network model in a video classification method.

The patch unit video inference unit 1142 may calculate various inference values to which various neural network models in a video classification method are applied for each patch unit video. For example, for one patch unit video, K inference values associated respectively with K (here, K is an integer greater than or equal to 1) neural network models in a video classification method may be derived. For example, the first inference value associated with the first neural network model in a video classification method and the second inference value associated with the second neural network model in a video classification method may be acquired. X3D, Slowfast, I3D, etc. may be applied as a variety of video classification methods, but the scope of the present disclosure is not limited to these examples. In theory, there may be a neural network model with the most suitable detection performance, but in reality, a stable inference value may not always be maintained and an abnormal result may be derived sometimes due to various noise characteristics of an input video. Accordingly, various inference values to which various neural network models in a video classification method are applied may be derived and considered comprehensively, acquiring a stable inference result.

For example, when M sample videos corresponding to M noise features are generated for a sample video corresponding to each of the N cameras, N*M sample videos may be prepared. Each of the N*M sample videos may be partitioned into P (P is an integer greater than or equal to 2) patch unit videos, preparing N*M*P patch unit sample videos. For each of these patch unit sample videos, K inference values corresponding to K neural network models in a video classification method may be derived. Accordingly, N*M*P*K inference values may be acquired. Considering the features of the present disclosure in which inference and analysis are performed in a patch unit, N*M*K inference values may be acquired for each patch unit.

The patch unit inference value analysis unit 1144 may comprehensively analyze inference values (e.g., N*M*K inference values) for various patch unit videos corresponding to the same one grid location (or patch location) during the same one time period.

The videos may be produced from multiple cameras (e.g., cam(1), cam(2), . . . , cam(N)), images to which different noise features are forcibly given may be additionally produced for each camera image (e.g., video(1_1), video(1_2), . . . , video(1_M), . . . , video(n_1), video(n_2), . . . , video(N_M)) and inference values obtained by applying a video classification neural network model in various ways to patch images partitioned from each image may be calculated (e.g., prediction(1_1_1), . . . , prediction(N_M_K).

In comparison with a method for detecting whether a flood occurs by using one inference value obtained by applying one video classification neural network model to one patch unit video partitioned from a video generally captured by one camera, the present disclosure calculates and statistically process N*M*K inference values for each patch unit and determines whether a flood occurs by using an analysis result (i.e., an analysis value).

The sample unit flood degree analysis unit 1146 may collect whether videos in a patch unit are flooded in a sample unit (i.e., collect P analysis results in a patch unit), calculate the number of patches determined to be flooded among all patches within a sample and calculate a flood degree in the entire region (i.e., screen) visible to a camera.

For example, based on N*M*K inference values for each patch unit video, an analysis value for each patch unit may be derived. When one screen is partitioned into P (partially overlapping) patches, a flood degree in the entire screen region unit (i.e., sample unit) may be determined by collecting P analysis values corresponding to P patch units.

For example, since there are regions corresponding to terrain that may not be flooded such as the sky, the forest, etc. within a screen in a sample unit, a flood degree may be determined based on whether patch(es) (e.g., P_v analysis values) belonging to a region that may be flooded (i.e., a valid region) excluding these regions are flooded.

This valid region may be pre-designated by a user or may be automatically designated based on terrain analysis within a sample video.

The sample unit flood degree analysis unit 1146 may generate detection information by tracing a flood rate (i.e., the number of patches having an analysis value corresponding to a flood) within the valid region of a camera screen and transmit it to the flood warning unit 1160.

For example, it may be assumed that the entire screen is partitioned into nine patches, Patches 1, 2, 3 and 4 among them correspond to an invalid region and Patches 5, 6, 7, 8 and 9 are a valid region (e.g., P_v=5).

In this case, when an analysis value for at least one of the five valid regions represents a flood, it may be determined that a flood is detected in a sample unit. Alternatively, when analysis values greater than or equal to (or greater than) the number of thresholds (e.g., ½ of the total number of patches, or ⅓ of the total number of patches, etc.) among the five valid regions represent a flood, it may be determined that a flood is detected in a sample unit.

Meanwhile, when an analysis value does not represent a flood in all of the five valid regions, it may be determined that a flood is not detected in a sample unit. Alternatively, when analysis values less than (or less than or equal to) the number of thresholds (e.g., ½ of the total number of patches, or ⅓ of the total number of patches, etc.) among the five valid regions represent a flood, it may be determined that a flood is not detected in a sample unit.

FIG. 5 is a diagram for describing an example of a flood detection method according to the present disclosure.

In S510, an apparatus may acquire N sample video data respectively corresponding to N) (N is an integer greater than or equal to 1) cameras.

In some examples, N sample video data may correspond to video data in the predetermined time period of N video data capturing the same direction through N cameras.

In S520, an apparatus may calculate a sample unit flood degree based on N sample video data and K (K is an integer greater than or equal to 1) neural network models in a video classification method.

In some examples, N*K inference values may be acquired by applying K neural network models in a video classification method to each of the N sample videos. These inference values may be collected to derive an analysis value for whether a flood occurs and calculate a sample unit flood degree.

In some examples, M (M is an integer greater than or equal to 1) different noise features may be given to each of the N sample video data, generating N*M sample videos. For example, N*M*K inference values may be acquired by applying K neural network models in a video classification method to each of the N*M sample videos. These inference values may be collected to derive an analysis value for whether a flood occurs and calculate a sample unit flood degree.

In some examples, each of the N*M sample video data may be partitioned into P (P is an integer greater than or equal to 2) patch unit videos. For example, a part or all of the P patch unit videos may include an overlapping region. For example, N*M*K inference values may be acquired for each patch unit video by applying K neural network models in a video classification method to each of the P patch unit videos. For example, for each patch unit video, an analysis value based on N*M*K inference values may be acquired. For example, a sample unit flood degree may be calculated based on P analysis values for P patch unit videos. In this case, a sample unit flood degree may be calculated based on P_v analysis values corresponding to a valid region among P analysis values. If an analysis value greater than or equal to a predetermined number of thresholds (e.g., 1 or P/2) among P_v analysis values has a value corresponding to a flood, detection information representing that a flood is detected in a sample unit may be generated. If an analysis value less than a predetermined number of thresholds (e.g., 1 or P/2) among P_v analysis values has a value corresponding to a flood, detection information representing that a flood is not detected in a sample unit may be generated.

In S530, an apparatus may output flood information based on a sample unit flood degree.

In some examples, output flood information may be transmitted to a control center or may be used by an apparatus itself to output a flood warning corresponding to flood information.

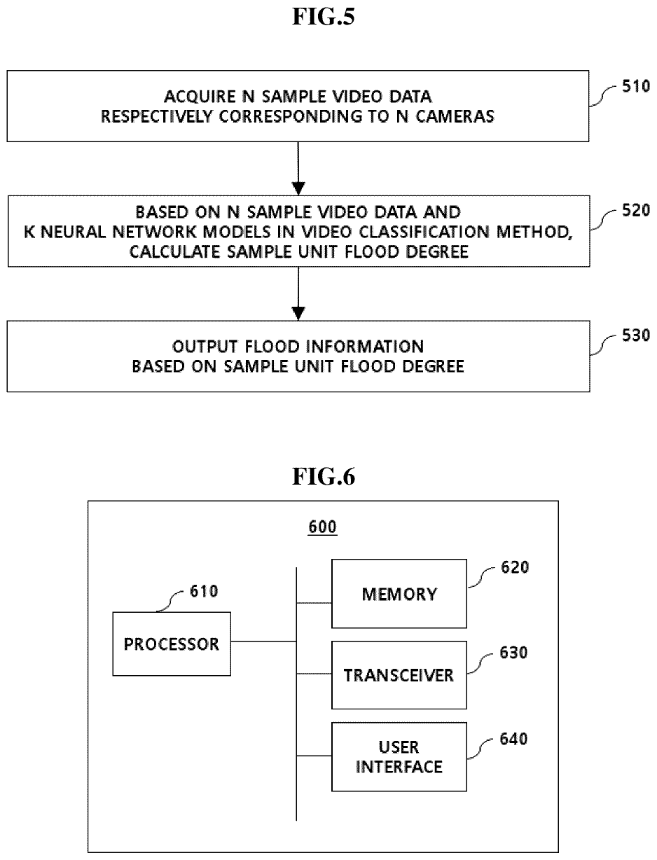

FIG. 6 represents an example of a block diagram for a flood detection apparatus according to the present disclosure.

The flood detection apparatus 600 may include at least one processor 610, at least one memory 620, at least one transceiver 630, at least one user interface 640, etc. The memory 620 may be included in the processor 610 or may be configured separately. The memory 620 may store instructions that causes the apparatus 600 to perform an operation when being executed by the processor 610. The transceiver 630 may transmit and/or receive a signal, data, etc. that are exchanged by the apparatus 600 with other entities. The user interface 640 may receive a user's input for the apparatus 600 or provide the output of the apparatus 600 to a user. Among the components of the apparatus 600, components other than the processor 610 and the memory 620 may not be included in some cases, and other components not illustrated in FIG. 6 may be included in the apparatus 600.

The processor 610 may be configured to cause the apparatus 600 to perform the operation of an apparatus according to various examples of the present disclosure. Although not illustrated in FIG. 6, the processor 610 may be configured as a set of modules for performing each function. A module may be configured in the form of hardware and/or software.

For example, the processor 610 may be configured to acquire N sample video data respectively corresponding to N (N is an integer greater than or equal to 1) cameras through at least one transceiver 630 and store the same in the memory 620, calculate a sample unit flood degree based on N sample video data and K (K is an integer greater than or equal to 1) neural network models in a video classification method, and output flood information based on a sample unit flood degree through at least one transceiver 630.

Furthermore, the processor 610 may be configured to generate N*M sample video data to which M (M is an integer greater than or equal to 1) different noise features are given for each of the N sample videos and store the same in the memory 620, partition each of the N*M sample video data into P (P is an integer greater than or equal to 2) patch unit videos and store the same in the memory 620, apply K neural network models in a video classification method to each of the P patch unit videos to acquire/generate N*M*K inference values for each patch unit video and store the same in the memory 620, and generate flood information as in various examples described above based thereon.

According to various examples of the present disclosure described above, it is possible to achieve new and advantageous technical effects that a flood may be detected for 24 hours regardless of day or night, a flood may always be detected regardless of weather conditions such as rain, snow, fog, etc. and a flood may be detected more stably without accuracy issues due to a person's decreased concentration or cost issues such as sensor maintenance, etc.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by software and software may be recorded in a recording medium. A component, a function and a process described in illustrative embodiments may be implemented by a combination of hardware and software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

1. A system for detecting a flood, the flood detection system comprising:
a camera array including N (N is an integer greater than or equal to 1) cameras; and
a flood detection processing apparatus that generates flood information by applying a neural network model in a video classification method based on N sample video data acquired from the camera array.

2. The system of claim 1, wherein:
the N sample video data corresponds to video data in a predetermined time period of N video data capturing a same direction through the N cameras.

3. The system of claim 2, wherein:
N*M sample videos in which M (M is the integer greater than or equal to 1) different noise features are given to each of the N sample video data are generated.

4. The system of claim 3, wherein:
each of the N*M sample video data is partitioned into P (P is an integer greater than or equal to 2) patch unit videos.

5. The system of claim 6, wherein:
a part or all of the P patch unit videos include an overlapping region.

6. The system of claim 4, wherein:
N*M*K inference values are acquired for each patch unit video by applying K (K is the integer greater than or equal to 1) neural network models in the video classification method to each of the P patch unit videos.

7. The system of claim 6, wherein:
for the each patch unit video, an analysis value based on the N*M*K inference values is acquired.

8. The system of claim 7, wherein:
a sample unit flood degree is calculated based on P analysis values for the P patch unit videos.

9. The system of claim 8, wherein:
the sample unit flood degree is calculated based on P_v analysis values corresponding to a valid region among the P analysis values.

10. The system of claim 9, wherein:
when an analysis value greater than or equal to a predetermined number of thresholds among the P_v analysis values has a value corresponding to the flood, detection information representing that the flood is detected in the sample unit is generated.

11. The system of claim 9, wherein:
when an analysis value less than a predetermined number of thresholds among the P_v analysis values has a value corresponding to the flood, detection information representing that the flood is not detected in the sample unit is generated.

12. The system of claim 8, wherein a flood detection processing apparatus performs at least one of:
outputting flood information based on the sample unit flood degree, or outputting a flood warning corresponding to the flood information.

13. The system of claim 1, wherein:
the system further includes an illuminator that illuminates a direction captured by the N cameras.

14. The system of claim 13, wherein:
flood-related feature information is added to N video data captured through the N cameras by patterned light irradiated from the illuminator.

15. The system of claim 14, wherein:
a neural network model learned about a video to which the flood-related feature is added is applied to the flood detection processing apparatus.

16. The system of claim 13, wherein:
the illuminator operates according to a predetermined schedule.

17. The system of claim 13, wherein:
whether the illuminator operates is adjusted according to a control signal by the flood detection processing apparatus.

18. A flood detection processing apparatus, the apparatus comprising:
at least one transceiver;
at least one memory; and
at least one processor,
wherein the at least one processor is configured to:
acquire N sample video data respectively corresponding to N (N is an integer greater than or equal to 1) cameras through the at least one transceiver and store the same in the memory;
calculate a sample unit flood degree based on the N sample video data and K (K is the integer greater than or equal to 1) neural network models in a video classification method; and
output flood information based on the sample unit flood degree through the at least one transceiver.

19. A flood detection processing method, the method comprising:
acquiring N sample video data respectively corresponding to N (N is an integer greater than or equal to 1) cameras;
calculating a sample unit flood degree based on the N sample video data and K (K is the integer greater than or equal to 1) neural network models in a video classification method; and
outputting flood information based on the sample unit flood degree.
